(19) United States
(12) Patent Application Publication
(10) Pub. No.: US 2008/0095196 A1
(43) Pub. Date: Apr. 24, 2008

(54) UNIT TO UNIT TRANSFER SYNCHRONIZATION

(75) Inventors: N. Andrew Weatherhead, Ayr (CA); Mark K. Carmount, Ayr (CA)

Correspondence Address: ROCKWELL AUTOMATION, INC./(AT), ATTENTION: SUSAN M. DONAHUE, E-7F19, 1201 SOUTH SECOND STREET, MILWAUKEE, WI, 53204, US

(73) Assignee: ROCKWELL AUTOMATION TECHNOLOGIES, INC., Mayfield Heights, OH (US)

(21) Appl. No.: 11/864,134

(22) Filed: Sep. 28, 2007

Related U.S. Application Data
(60) Provisional application No. 60/890,973, filed on Feb. 21, 2007.
(60) Provisional application No. 60/862,403, filed on Oct. 20, 2006.

(51) Int. Cl. H04J 3/06

(52) U.S. Cl. 370/503

(57) ABSTRACT

A system facilitates improved module organization. The system includes a communication component that enables interaction between a primary module and at least one subsequent module. In addition, a synchronization component that coordinates operation of the primary module with at least one subsequent module through utilization of the communication component, where the synchronization component is included upon the primary module.

### CROSS REFERENCE TO RELATED APPLICATION

This application claims the benefit of U.S. Provisional Patent Application No. 60/862,403 entitled MODULE CONTROL AND STATE PROPAGATION, and filed on Oct. 20, 2006, the entirety of which is herein incorporated by reference. This application also claims the benefit of U.S. Provisional Patent Application No. 60/890,973 entitled MODULE CONTROL AND STATE PROPAGATION, and filed on Feb. 21, 2007, the entirety of which is herein incorporated by reference.

### TECHNICAL FIELD

The claimed subject matter relates generally to industrial control systems and more particularly to module components that communicate synchronization information among themselves.

### BACKGROUND

One type of industrial control process is referred to as a batch process, which involves subjecting raw materials to processing steps using one or more pieces of equipment to produce a “batch” of product. Efforts to automate batch processing have led to the formation of standards committees by members of industries involved in batch processing and suppliers of batch processing equipment, among others. The general purpose of these standards committees has been to define uniform standards for automated batch processing. One such standard has been promulgated by the International Society for Measurement and Control, an international organization concerned with issues of process control. This standard is entitled Batch Control Part 1: Models and Terminology and is often referred to as the ISA S88.01-1995 standard (or “S88” for purposes of this application).

The S88.01 standard defines models of equipment and procedures for use in automated batch processes, as well as terminology for use in referring to those models and their elements. The S88.01 standard defines a “batch process” as a process that leads to the production of finite quantities of material by subjecting quantities of input materials to an ordered set of processing activities over a finite period of time using one or more pieces of equipment. A “batch” is defined as the material that is being produced or has been produced by a single execution of a batch process.

Batch-processing equipment (e.g., controllable elements such as valves, heaters, mixers, and so forth) is operated according to procedures to produce a batch. Generally, such equipment is referred to synonymously as equipment, equipment modules, processing equipment, or physical elements. The procedures to operate such physical elements are often referred to by the S88.01 standard as the “procedural model.” According to the S88.01 standard, the procedural model is structured as a hierarchical ranking of procedures, with the highest level encompassing each of the lower levels, the next highest level encompassing each of the levels below it, and so on. Typically, the levels of the S88.01 procedural model of a particular application are, in descending order: the “procedure;” the “unit procedure;” the “operation;” and the “phase.”

The term “procedural element” generally refers to components that employ any of the levels of the S88.01 procedural model, not just to those of the “procedure” level or any other single level of the procedural model. The highest-level procedural element of interest is referred to as a procedure, which is made up of one or more unit procedures. Each unit procedure is in turn made up of one or more operations, which are each in turn made up of one or more phases. The S88.01 procedural model does not preclude definition and use of other hierarchical levels, nor does it require that each level be applicable in particular applications. Rather, the standard is intended to provide a broad, standardized model for describing the procedures followed in automated batch-process control.

Conventional systems employing standard process models such as S88 and the like often implement many modules such as Equipment Modules or Control Modules that control a given industrial process. Generally, various modules communicate between one another in order that various processes can be synchronized between the modules. For instance, one process module can need to complete a vessel cleaning operation before a subsequent module can add ingredients to the vessel. Custom code is generally written to perform such synchronization between modules.

### SUMMARY

The following discloses a simplified summary in order to provide a basic understanding of some aspects described herein. This summary is not an extensive overview nor is intended to identify key/critical elements or to delineate the scope of the various aspects described herein. Its sole purpose is to disclose some concepts in a simplified form as a prelude to the more detailed description that is disclosed later.

General synchronization components within modules operate to allow communication between the modules concerning status. For instance, a synchronization component can be embedded in a Unit module or an Equipment Verification Module, which allows a recipe builder (recipe=procedural control) to insert a phase in a recipe which acts on the control system, and allows synchronization of Units at the correct place or time in the procedure. The synchronization component also allows Work In Progress (WIP) lot identification to be transferred between Units, thereby simplifying analysis of genealogy data, for example. Equipment status classification can also be provided. This solution breaks the status of equipment down into specific categories of resident states. Example categories include: Cleanliness; Quality; Availability (or production); Process; and so forth. By monitoring the state of equipment, and reporting equipment status, control elements which act on the equipment (for example procedure) can evaluate the state of a vessel to facilitate the recipe or program can be executed.

To the accomplishment of the foregoing and related ends, certain illustrative aspects are described herein in connection with the following description and the annexed drawings. These aspects are indicative of various ways, which can be practiced, all of which are intended to be covered herein. Other advantages and novel features can become apparent from the following detailed description when considered in conjunction with the drawings.

### BRIEF DESCRIPTION OF THE DRAWINGS

FIG. 1 is a schematic block diagram illustrating industrial control modules with synchronization components as well as a controller for an industrial automation system.

FIG. 2 is a block diagram of an example process that received various modules with synchronization components.

FIG. 3 illustrates an example deconstructed synchronization component.

FIG. 4 illustrates an example module that operates in conjunction with a process.

FIG. 5 illustrates an example interaction for coordination between two modules.

FIG. 6 illustrates a module construction system.

FIG. 7 is a flow diagram illustrating an example module and synchronization component integration methodology.

FIG. 8 is a flow diagram illustrating methodology for modifying operation of a synchronization component.

FIG. 9 is a diagram illustrating module attributes.

FIG. 10 is a diagram illustrating example resource control modules.

FIG. 11 is a diagram illustrating a resource module.

FIG. 12 is a diagram illustrating example resource modules.

FIG. 13 is a diagram illustrating a resource control model.

### DETAILED DESCRIPTION

A system facilitates improved module organization. The system includes a communicator that allows for interaction between a primary module and at least one subsequent module. In addition, a synchronization unit coordinates operation of the primary module with at least one subsequent module through use of the communicator, where the synchronization unit integrates with the primary module.

It is noted that as used in this application, terms such as “component,” “module,” “model,” and the like are intended to refer to a computer-related entity, either hardware, a combination of hardware and software, software, or software in execution as applied to an automation system for industrial control. For example, a component can be, but is not limited to being, a process running on a processor, a processor, an object, an executable, a thread of execution, a program and a computer. By way of illustration, both an application running on a server and the server can be components. One or more components can reside within a process and/or thread of execution and a component can be localized on one computer and/or distributed between two or more computers, industrial controllers, and/or modules communicating therewith.

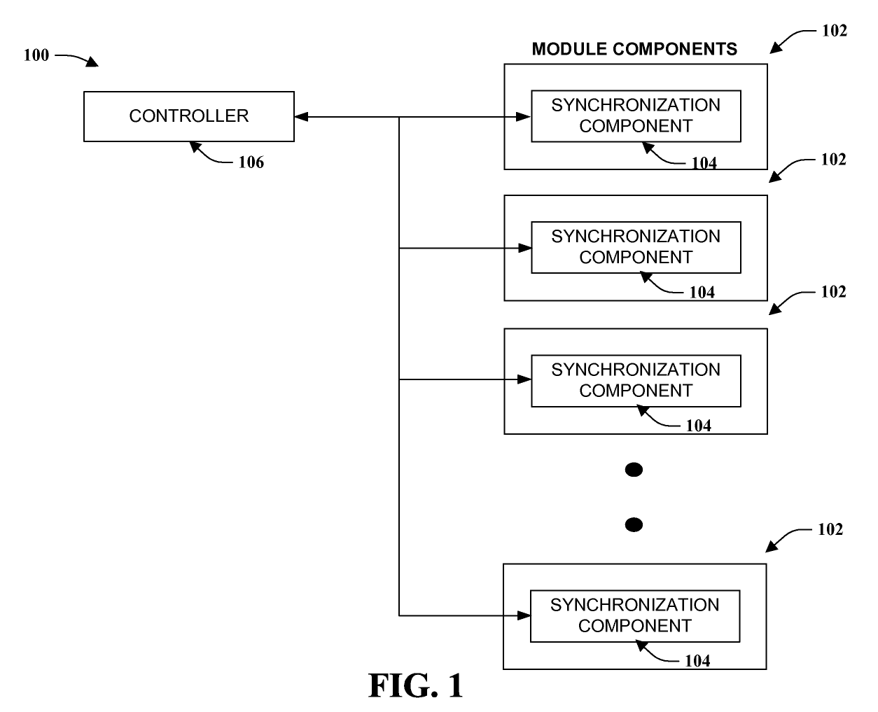

Referring initially to FIG. 1, various industrial control enhancements 100 are provided for an industrial automation system. At 102, module components are disclosed. In a single process (e.g., mixing process, baking process), different modules operate to perform different tasks of the process. Module components integrate together to create a relatively seamless procedure. For instance, in a soda making process, there can be a water pouring module, a carbonation module, a syrup module, a mixing module, and a bottling module. These different modules can operate together to take raw materials (e.g., water, syrup) and create a carbonated beverage. The soda making process is used through the subject specification as an example of implementation of aspects disclosed herein.

At 104, a synchronization component provides harmonization between various module components. Different components can benefit from receiving different information types. For example, a mixing module can include a timer that determines how long the mixing module should operate based on an amount of received materials. Therefore, the mixing component should not select a time until material information has been received. A synchronization component communicates with other modules and instructs the modules how to operate and/or provides information on module operation that enables other modules to act upon the information. Different statuses can be provided between modules to allow for coordination of operation. Example statuses include cleanliness (e.g., not clean, rinsed, cleaned, sanitized, etc.), process state (e.g., empty, filling, processing, emptying, etc.), alarm, availability, quality, campaign, etc. In addition, coordination includes an ability to communicate batch identification, previous batch identification, work in progress lot number, destination, cycle counts, etc. Furthermore, the synchronization component can communicate batch data (e.g., product name, product identification, recipe identification, destination, order number, etc.) and quality status (e.g., testing, released, held, failed, test batch, etc.) to another module thorough coordination.

In one aspect, the synchronization component breaks module status (e.g., equipment modules) into different state categories and notifies other modules of a category they should enter. Example categories can include cleanliness, quality, availability, non-operational, ready, etc. When different modules are operating in one process, certain modules will have specific information that is important in operation of other modules. For instance, a mixing module can be experience a cleaning operation where an inner lining of a mixer bowl is being scrubbed. It can be detrimental for water to enter the mixing bowl since the bowl is being occupied and it is likely harmful cleaning chemicals will interact with added water. Therefore, a synchronization component of the mixing module can send a signal to a water pouring module that it should stop operation until cleaning is complete because cleaning chemicals are in the mixer. When cleaning is complete, the mixing module sends a signal to the water pouring module that cleaning has completed. The water pouring module can determine how to proceed when a state change takes place.

At 106, a controller regulates operation of the industrial control enhancements 100. Prior to a process commencing, various modules can be in different states. A controller can manage initial states and instruct when a process should commence, end, etc. For instance, a mixing component can be in a cleaning state while the bottling module is in a power conservation state. The controller can receive a message that the process is to start. A signal is sent to at least one module that the module should take action consistent with starting the process.

Conventionally, synchronization takes place at a central location and not as a part of individual modules. Moreover, customized programmer-written code is used to complete synchronization between modules. Market trends gravitate toward programmer written code since synchronization can be tailor-made to modules that are in a system. However, as different modules are added and removed, originally written code can become less practical since there are system changes from a time when code was written. Therefore, allowing different modules to synchronize with one another enables a process that can adapt to subsequent changes.

Modules can include other modules including nested modules where standard module behaviors and attribute patterns can be represented using common data model representations for module classes, module templates and module inheritance. Module classes and templates can be maintained in libraries, which facilitate access to desired system functionality and further promote system integration. Resources can have various states associated therewith such as common S88 state classifications including idle, hold, abort, run, reset, stop, restart, and so forth where the module can disclose logic to represent state machines that manage the state of the resource. During application, resource modules (described below) can take on the name of the resource that is the primary focus on the module. For example, an Equipment module is primarily focused on coordination of equipment but can involve personnel in the process. Similarly, a Personnel module is focused on coordination of personnel but can involve other resources in the process. A Control Module that manages a material can be referred to as a Material Control Module and so forth.

It is noted that components associated with the system 100 can include various computer or network components such as servers, clients, programmable logic controllers (PLCs), communications modules, mobile computers, wireless components, control components and so forth that are capable of interacting across a network. Similarly, the term PLC as used herein can include functionality that can be shared across multiple components, systems, and/or networks. For example, one or more PLCs can communicate and cooperate with various network devices across the network. This can include substantially any type of control, communications module, computer, I/O device, sensor, Human Machine Interface (HMI) that communicate via the network, which includes control, automation, and/or public networks. The PLC can also communicate to and control various other devices such as Input/Output modules including Analog, Digital, Programmed/Intelligent I/O modules, other programmable controllers, communications modules, sensors, output devices, and the like.

The network can include public networks such as the Internet, Intranets, and automation networks such as Control and Information Protocol (CIP) networks including DeviceNet and ControlNet. Other networks include Ethernet, DH/DH+, Remote I/O, Fieldbus, Modbus, Profibus, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

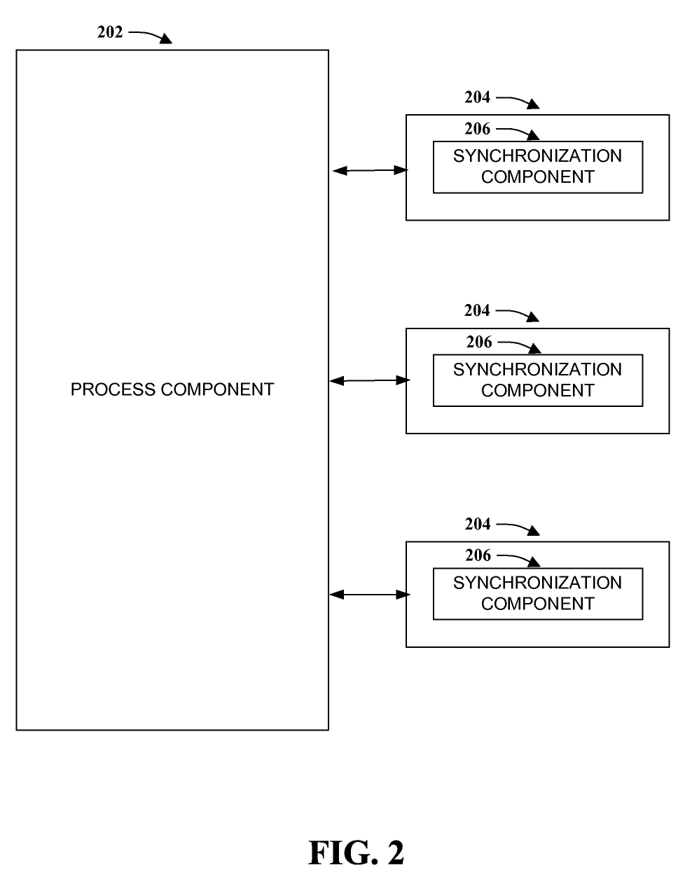

FIG. 2 illustrates a process component 202 engaging with different modules 204. The process component can be constructed by a company and be used in continuous operation to create a product. However, as technology develops, different modules can be added that assist the process component in operation. For instance, in the soda making process a bottling machine can be employed to package a soda product. However, it can be come cheaper to package soda in aluminum cans. In one example situation, while some patrons desire products sold in bottles, more individuals will purchase a product if it is packaged in aluminum cans.

Therefore, several new modules can engage the process to allow for bottling in aluminum cans and bottles. A conveyance module determines how much soda should be bottled and how much soda should be canned a canning module packages an amount of soda designated for cans. Modules added to the system can have synchronization components that can change states of existing modules.

In one embodiment, at least one module 204 operates as a safety component that performs a failure control operation upon a primary module or subsequent module. Example failure control operations include monitoring modules to determine if they are close to a failure (e.g., reaching a dangerous temperature), corrects an error, modifies operation of other modules 204, send a failure notice, etc. A synchronization component 206 can be a module embedded in the safety component 204. The safety component can utilize a resource to perform a failure control operation. Example resources include a presence sensor device, a safety switch, an interlock switch, a safety relay, an emergency stop device, a cable pull and enable switch, a safety controller, or a combination thereof.

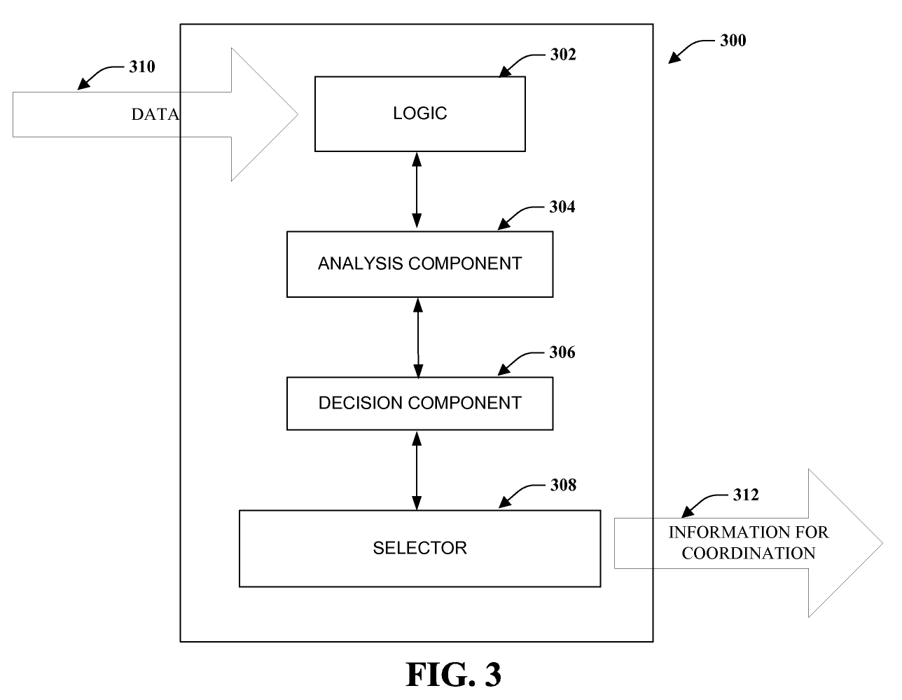

With FIG. 3, a representative synchronization component 300 is disclosed in detail. At 302, logic is used to regulate internal operation of the synchronization component. Logic can follow mathematical-based algorithms in determining a manner for the synchronization component to operate. For instance, if a synchronization component were to transfer a large sum of information that relates to the module to an auxiliary location (e.g., to a supplemental module), then there is a likelihood that the auxiliary location can become overburdened and performance can suffer. Therefore, the logic can be discriminating toward what information should be transferred and configure to disregard less important data.

At 304, an analysis component examines information that relates to a module supporting the synchronization component. Different characteristics of information (e.g., metadata) can influence how the synchronization component proceeds. A typical synchronization component can operate in at least two practices, with practices relating to coordination of modules. In a first practice, the synchronization component can relay information concerning module operation to another module. Based on the relayed information, a receiving module can alter its practice. However, in a second practice, a synchronization component can receive information from another module and alter its practice based on received information.

The analysis component can make an examination of internal module operation to assist logic in making a determination as to what information should be sent to another module for coordination. In addition, the analysis component can evaluate received information from another module to determine how a change should take place. For example, in the soda process, a synchronization component of a conveyance module can receive a notice that an error has occurred for the canning module. The analysis component can determine that a mixture should not longer be sent to the canning module, but that mixture can continue to be sent to the bottling module.

At 306, a decision component makes resolutions based on examinations performed by the analysis component. Using the above-mentioned example, since the analysis component discovers a modification that should be made to the canning portion of the conveyance module, the decision component resolves to follow an action consistent with the analysis and instruct the canning portion to cease operation. In addition, a resolution can be made with regard to sending information. For instance, the analysis component can find information that relates to a problem occurring in a module and the decision component can determine if the information can assist other modules in coordinating operation.

At 308, a selector makes a choice based on a resolution of a decision component. In a context of sending information, the selector can choose specific information that relates to a resolution of the decision component. In an illustrative example, an error can occur in the module and the decision component can resolve that information should be sent to at least one other module. The selector determines information that should be transmitted (e.g., a notice that an error occurred, a detailed explanation of the error and estimation as to why it occurred, etc.) In addition, the selector can be used in choosing a response that can be returned for received information (e.g., a conformation, an instruction for further action, a rejection, etc.)

In example operation, data 310 enters the synchronization component and is processed by logic. Example data is that a module holding the synchronization component has completed operation. If the logic determines that the data should be transmitted to another location, then the analysis component evaluates characteristics of the data. A decision component determines a relevant action based on the characteristic evaluation. The selector chooses information to transport to another module and selected information for coordination 312 is emitted.

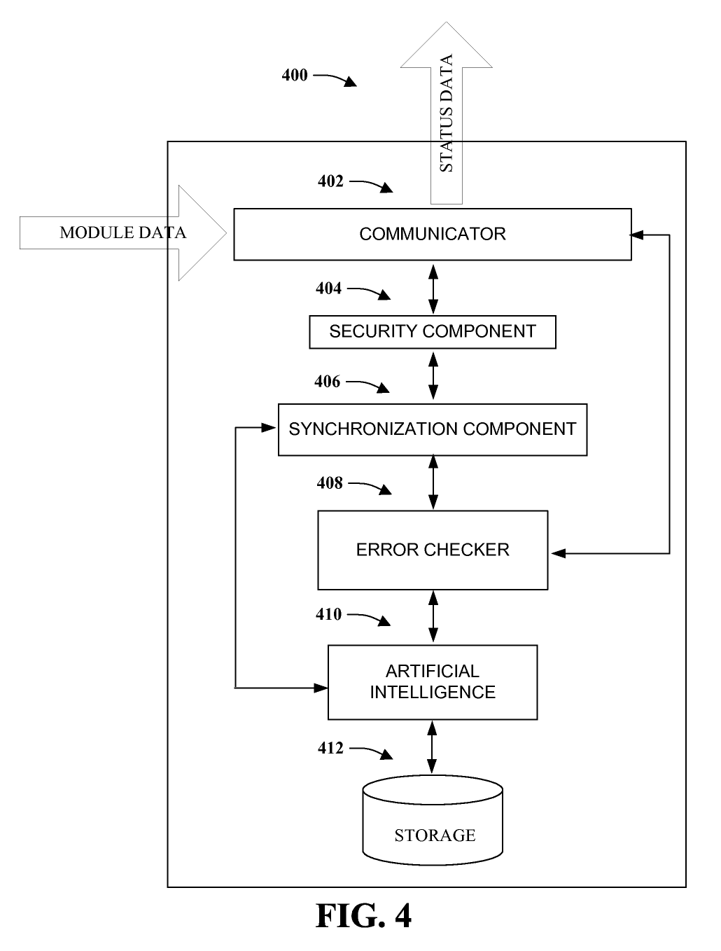

Referring now to FIG. 4, a detailed module 400 is disclosed that can be representative of a module with representative enhancements 100 of FIG. 1. At 402, a communicator is used to receive a state change request, commonly originating from a state change component of another module. Moreover, the communicator can transmit data to other units that reflect a state change. The communicator can receive data and/or transmit data in a wired as well as wireless manner.

At 404, a security component regulates various aspects related to the module. A module operating off incorrect data can produce a number of undesirable results, including process failure. The security component regulates operation of the process to determine if the module should act upon received data. In one instance, the security component can verify that received data is from a trustworthy source. If a source is not trustworthy, then the security component can perform a check to determine if the new source should be trusted. For example, the security component can make a request to a central database to identify the unknown item. If the security component cannot ascertain trustworthiness of information, then the data is not entered and coordination does not take place.

The security component can also ascertain the viability of data itself. For instance, data can produce a state change that is detrimental to a process component. Using the soda making example, a cleaning module can be engaged in applying chemicals to a mixing bowl. Data can be sent to the mixing module that it should stop functioning since a diagnostics check will be performed. However, leaving the chemicals upon the mixing bowl for an extended amount of time can cause irreparable damage to a mixing surface. Therefore, the security component can ignore the data that instructs the mixing bowl to stop operation and transmit a signal to the diagnostics machine that the request should not be followed. At 406, a synchronization component operates as disclosed in other portions of the subject specification.

At 408, an error checker determines if the synchronization component is following data appropriately. In addition, the error checker determines that following data produces an unforeseen error. In an illustrative example, a bottling module can be instructed to place soda into bottles. A received instruction can state that the bottling module should resume from a previously instructed state. However, when bottling resumes, a gear breaks and bottling does not occur as expected. The error checker can identify the error and make an adjustment, such as instructing the bottling module to stop operation.

At 410, artificial intelligence is employed to make adaptive modifications concerning operation of the module and specifically operation of the synchronization component. If data from a particular module is consistently causing errors in a process, then the artificial intelligence can learn that the data from the module should not be followed. Based on what is learned by the artificial intelligence, operation of various components can be modified. For instance, if the synchronization component is sending out data that causes unnecessary delays, then the artificial intelligence can modify operation of the synchronization component.

Artificial intelligence makes at least one inference or at least one determination or at least one of each in relation to module coordination. Various scenarios can occur that are processed by the artificial intelligence. The artificial intelligence can also be adaptive (e.g., in a manner similar to adaptation of the artificial neuron network.) and thus change as conditions are learned that related to operation of the module(s). In addition, the artificial intelligence can make modifications with regards to other disclosed units. For instance, logic used by the synchronization component can be modified based on inferences and/or determination made by the artificial intelligence.

Artificial intelligence can employ one of numerous methodologies for learning from data and then drawing inferences and/or creating making determinations related to coordination between modules (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

At 412, there is storage that retains information relevant to operation of the module. Storage can hold logic that is used by various components in determining how to operate. For example, the synchronization component can utilize logic held in storage to determine what information should be sent out as well as what information should be followed. In addition, status data that is transmitted between modules can be held in storage until proper processing is completed.

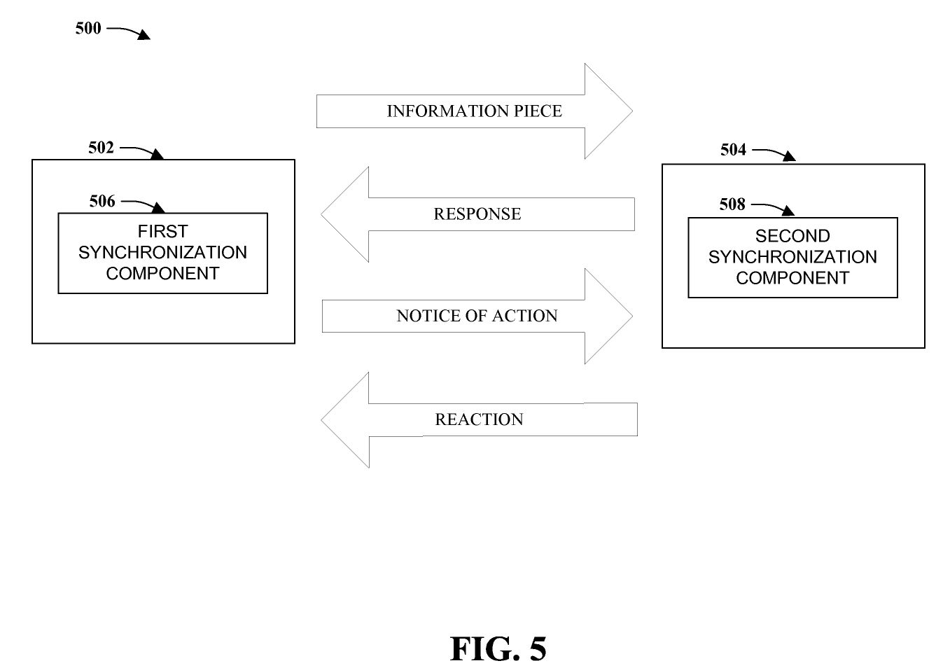

FIG. 5 discloses an example operation 500 of an aspect of the subject specification concerning interaction between two module components 502 and 504. At 506, a first synchronization component can determine there is a piece of information that should be transferred to another module. For example, the first synchronization component can request a material from a module with a second synchronization component. In a further illustration, a mixing module can make a request to receive syrup.

At 508, the second synchronization component responds to the request from the first synchronization component. The response can be a positive response (e.g., sending requested syrup), a negative response (e.g., a message stating the syrup will not be transmitted), an inquisitive response (e.g., a request for why the syrup is being requested.), etc. With the response, the first synchronization component and the second synchronization component have coordinated with one another relating to an operation (e.g., transferring syrup.)

Based on the response from the second synchronization component, the first synchronization component can take action. For instance, if an engaged module does not follow a requested instruction, then the first synchronization component can take an auxiliary action (e.g., send a message to an override component requesting that an action be followed.) A notice of the action can transfer to the second synchronization component. The second synchronization component can take a subsequent reaction. The correspondences can continue between the synchronization components to strengthen coordination.

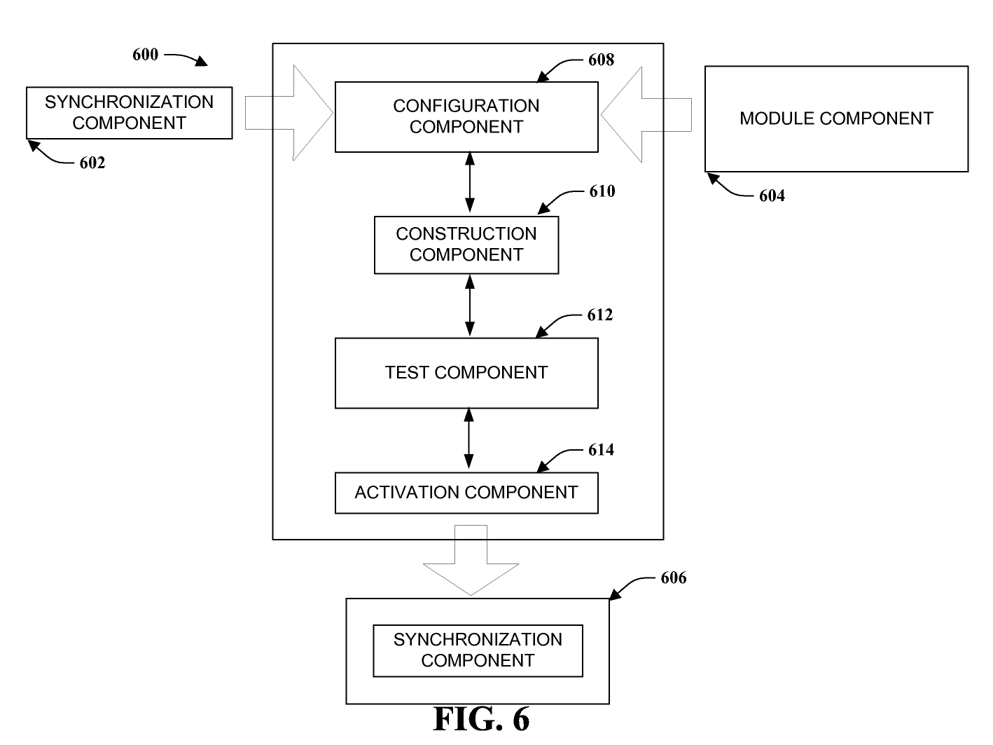

Referring now to FIG. 6, there is disclosure of an example operation 600 of an aspect of the subject specification concerning a synchronization component 602 and a module component 604 combining to form a single unit 606. At 608, a configuration component determines a synchronization component and/or module to integrate together. Logic and/or artificial intelligence can be used to assist the configuration component in determining what module and/or synchronization component should combine together. A non-exhaustive list of factors the configuration component can consider include a request from a unit (e.g., a module component), a need of a system, past history of a system, a user appeal, etc.

At 610, a construction component combines selected units (e.g., module component, synchronization component, etc.) together. Combination can take form through a number of different embodiments. In a purely computer code arrangement, the construction component can write code that bridges the synchronization component with the module component and/or modify code to allow for more seamless integration. In a hardware implementation, physical connections can be made between the synchronization component and the module.

At 612, a test component checks to determine if construction of a module integrated with a synchronization component operates in an appropriate manner. An appropriate manner is commonly a standard saved in storage. When a test occurs, results of the test can be compared against the saved standard. An outcome of a comparison can determine validity of a created unit. If the created unit is below the standard, then it can be disregarded, broken down and reconstructed, broken down with parts placed in new units, etc.

At 614, an activation component places the unit in a state to coordinate with another module. In an illustrative example, the activation component has the created unit send a message out requesting to locate other modules (e.g., placing the unit in an inquisitive state.) However, activation can also take a more passive form where the created unit is able to receive requests for information and/or to receive raw data transferred by another module. A communication component can engage another module to complete the coordination.

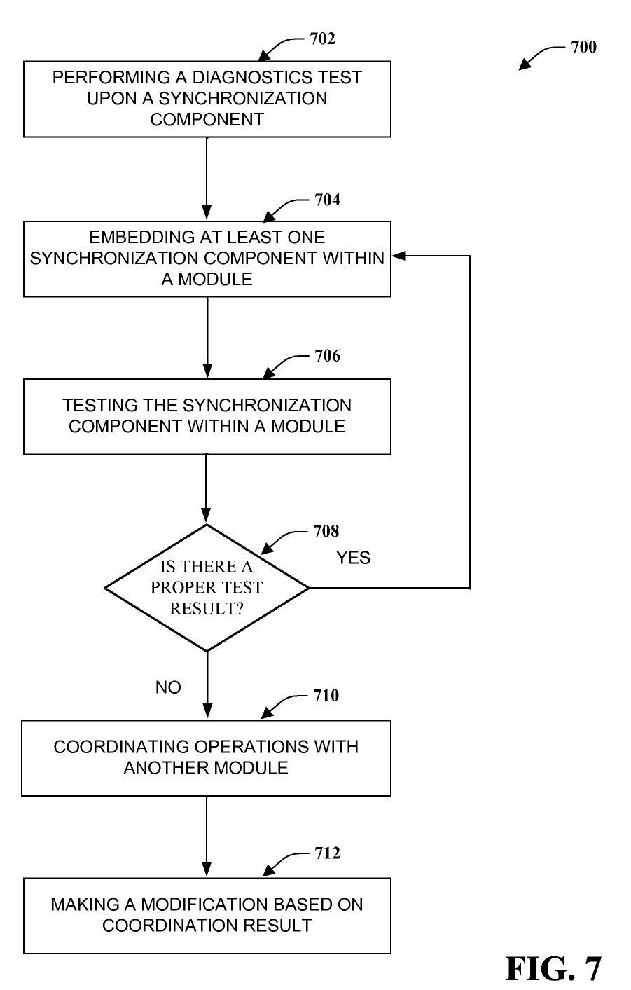

Referring now to FIG. 7, a methodology 700 is disclosed for construction of a module. At 702 a diagnostics test can be performed upon a synchronization component. Since various process operations occur through use of a synchronization component, it can be beneficial to check the synchronization component before it enters the process. Commonly, a diagnostics test includes running electrical signals upon the synchronization component. Results of electrical signal application can be compared against pre-determined values. Diagnostics can be run on computer code that is the synchronization component, such as running the code through at least one test session. If the synchronization component does not meet a set standard, then it can be disregarded. However, if the set standard is met, then the methodology continues.

At 704 there is embedding at least one synchronization component within a module. Embedding can take a number of different forms. In a physical embodiment, a synchronization component is electronically coupled to the module and then secured in place. However, in a computer implementation, code is integrated into code consistent with the module.

At 706, there is testing of the synchronization component within a module. While testing of the synchronization component alone takes place, different results can occur ones the synchronization component integrates with the module. For instance, if the synchronization component is computer code, errors can occur from interaction between the synchronization component and the module. Moreover, application of the synchronization component can cause damage to the module that should be identified before operation with another module.

At 708, a check occurs to determine if a result of testing is considered proper. A proper result is a result that meets at least one criterion designated for success. For example, the testing can produce a result that discloses the synchronization component operates with about 97% accuracy. Even though the testing produced about 3% failure, the result can still be proper if the criterion is that a failure rate should be less then about 5%. If the result is not proper, then a return can be made to 704 where a re-embedding can take place. However, it is to be appreciated that other actions are possible as a result of the check disclosing an improper result. In an illustrative example, the module embedded with a synchronization component can be rejected and not used, the module and synchronization component can be removed and attempted to fit in other appropriate units, a repair can be attempted, etc.

At 710, there is coordinating operations with another module. The synchronization component is employed to coordinate at least one operation with at least one other module. Commonly, operation of one module is dependent on operation of another module. Therefore, it can be beneficial that modules have information about other modules. For example, using the soda creation example, the synchronization component of a repair module can send a message to a bottling module requesting that the bottling module send a message to the repair module when the bottling module is done processing a current batch. When the repair module receives an appropriate message, then the repair module can operate upon bottling module. This allows modules to work together to operate an efficient process. Without coordination, the repair module could operate upon the bottling module while the bottling module is processing a batch of soda. This can increase a likelihood the bottling module will create an error and therefore a loss in profits (e.g., a loss in soda that can be sold for a profit.)

At 712, a modification is made based on a coordination result; commonly, the modification is toward operation of the module with the synchronization component and/or a modification upon another module. Coordination can function as an action for organizing operation while making a modification is implementing an operation. For instance, a water pouring module can delay placing water into a mixing bowl until chemicals have been removed from the mixing bowl.

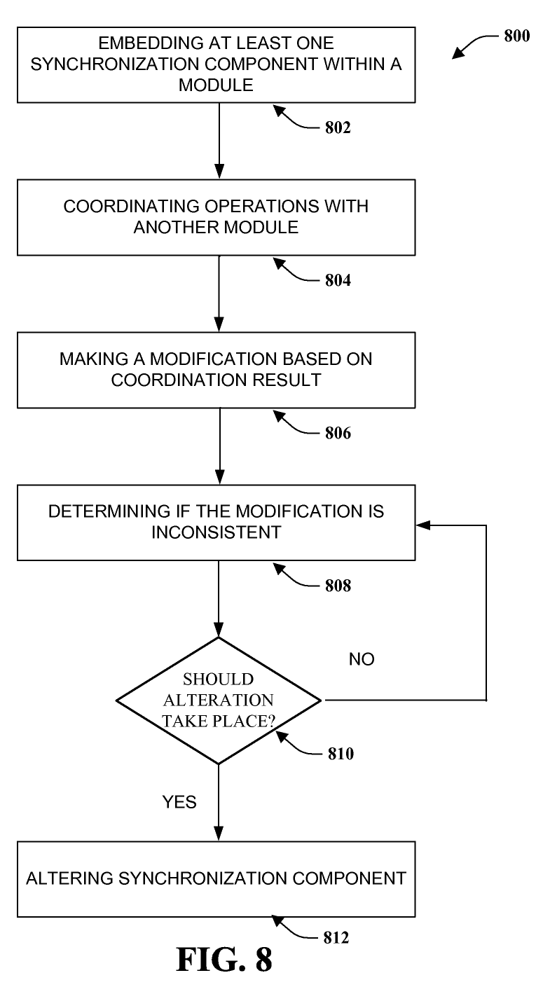

Referring now to FIG. 8, a methodology 800 divulges information relevant for synchronization of modules. At 802 there is embedding at least one synchronization component within a module. At 804, there is coordinating operations with another module. At 806 there is making a modification based on a coordinated result. 802-806 are described in greater detail through similar actions as disclosed in FIG. 6.

At 808 there is determining if the modification is inconsistent. Typically, a modification of a module operation is intended to create a certain outcome. For example, if in the soda process a water pouring module is halt pouring water, then this action should take place with minimal damage to the process. However, when a message is processed that water pouring should stop a flood can occur that damages process modules as well as auxiliary units (e.g., a plant where the process is operating.) Inconsistency can include having a modification produce an error.

Based on the determination, at 810 a check is performed to determine if an alteration should take place. If no alteration should take place (e.g., a modification is not inconsistent, an inconsistency does not rise to a level to warrant a modification, etc.), then the methodology can return to determining if the modification is inconsistent. Analysis can determine that a failure occurred (e.g., the water pouring module created a flood) and that there should be an alteration in operation of the synchronization component. Based on the analysis, the methodology can continue.

At 812, there is alteration of the synchronization component. Commonly alteration is performed by an artificial intelligence that uses storage to determine why an error occurred and/or makes an inference as to how the error can be corrected. If the synchronization component is a physical manifestation, then an alteration can take place through re-routing of electrical signals. However, if the synchronization component is based in computer code, then alteration can occur though changing code instructions. While the subject specification discloses the synchronization component to be a physical or software unit, it is to be appreciated that the synchronization component can manifest as a hybrid hardware/software component, as a component that utilizes hardware/software as a primary manifestation while software/hardware is used in a back-up capacity, etc.

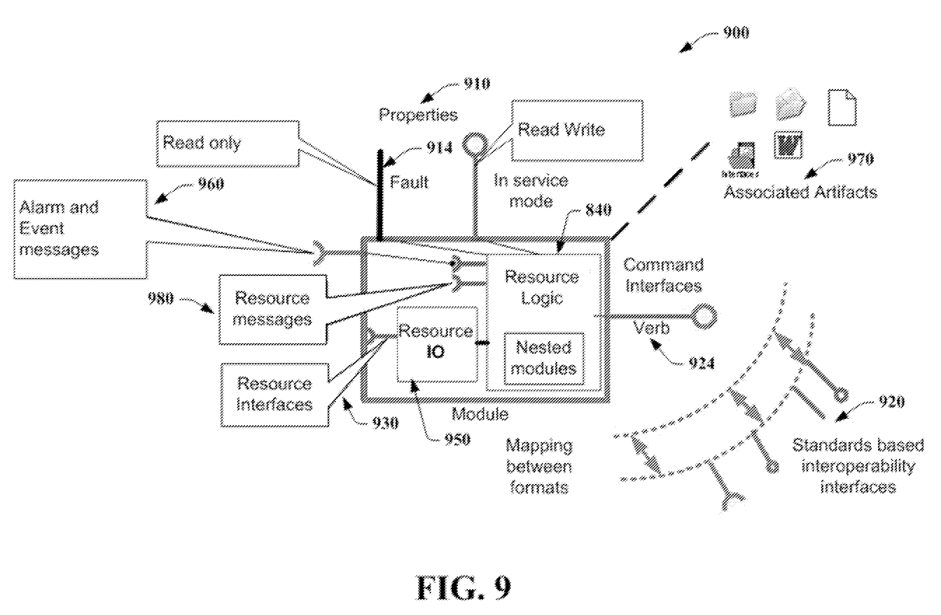

Referring now to FIG. 9, module attributes 900 are illustrated. The attributes 900 depicted in FIG. 9 include a common (or exemplary) representation that can be modules from modules. Generally, a set of standard attributes can be determined that are common to all modules. Similarly, for other types of modules described below, additional standard attributes can be defined. An example of a property 910 available on modules includes attributes such as Fault and Status at 914. Active resource modules (e.g., equipment and personnel) can support additional properties 910 such as available/unavailable.

Attributes disclosed below are represented associations from the module to objects, which can be internal in a common data model or elsewhere (e.g., CAD Files). At 920, standard public interfaces can be provided. These interfaces 920 publish verbs 924 that are available to external systems and are documented activities that hide the complexity of the underlying code used to implement the interface. Interfaces 920 can be considered into at least two common usage scenarios. For example, interfaces 920 can be used as access points that can be used to hook in real time diagnostics, security and so forth.

Public verbs 924 initiate an action within the module. The activity is described to clients of the interface 920. The implementation is considered private and is not disclosed to clients—for example, Open, Stop, Abort, Shut, and so forth. A data value property 910 provides public access to information that is used by the module during its operation and can be provided by request values and/or internal values (or an equivalent). The association of logic to transfer request values to internal values and vice versa are referred to as get and set logic for the value. It is noted that in a controller, if there is not a set routine to transfer request values to internal values, the internal value can overwrite the request value on the next scan providing read only capability.

In general, the properties 910 can be considered in at least two classifications. States have special significance for production systems and can have a specific set of values that can be represented by range or enumeration. A state can represent the current status of the primary resource being encapsulated by the module e.g., Percent open, Mode, Service (in, out), and so forth. Information that is used by the module during its operation includes access to data that is provided by interfaces 920. e.g., Conversion Map, Name, Description, expiry date, personnel contact information. Some properties 910 can be common to all instances of resource modules (e.g., scanned copy of resource specification documents), whereas other properties 910 are specific to each module instance (e.g., Status, percent open).

At 930, internal resource interfaces include interfaces from logic 940 in the module to the resource being managed at 950, where the logic includes code and/or configuration that processes a command and/or updates state and data properties. In some cases, this can be hardware such as I/O interfaces, or in other cases, it is to subordinate resource control modules that have direct interfaces. Some examples include I/O mapping, material management logic routines, and so forth. These interfaces 930 are internal to the module enabling the modules public interfaces 920 and properties 910 to be the boundary to other system components. Modules that wrap different resources but support the same public properties/interfaces can be exchanged without disrupting interfaces to other components. Generally, I/O mapping and system messaging interfaces are exposed during deployment bind processes. When bound, external interfaces 920 to runtime systems can then consider these interfaces as internal.

At 960, alarm and event messages can be provided which include messages that exposed as runtime messages visible to external systems during the execution of the module. This includes alarms and events explicitly coded by the developer and system messages promoted to be visible by external systems. At 970, one or more artifacts include information that document the operation and structure of the resource such as for example, wiring diagrams, warranties, payroll, parts supplier information, and so forth. Visualization aspects include associated graphics that disclose the resource state and properties to applications interacting with the resource. For example: faceplates, icons, state overlays, edit dialogs, help files. At 980, system messages allow modules to listen for and publish data model messages to external components. Inbound messages are typically used to manage modules (configure, initialize, propagate properties, and so forth) and publish messages on module activity (resource state, data model messages, and so forth).

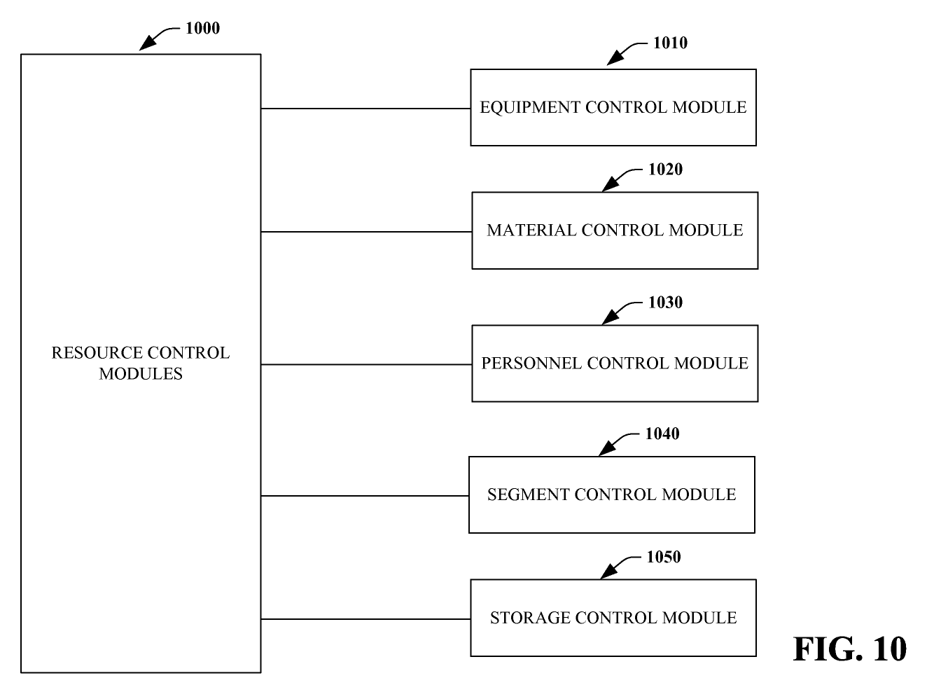

Turning to FIG. 10, example resource control modules 1000 are illustrated. In general, resource control modules 1000 provide simple control of one or more resources. The resource control module (RCM) 1000 represents the logic to manage the state or data of the resource and can contain other resource control modules to achieve its respective functionality. The RCM 1000 provides public interfaces via actions and properties. In some cases, an action can be a simple bit value or a request value that is interfaced to internal values in the module and in other cases more complex logic can be provided. The RCM 1000 can include other resource control modules and can promote a command to be represented as segment resource control interface. Example forms of the RCM 1000 include:

At 1010, an Equipment Control Module (Common name=“Control Module”) CM. The simplest form of basic regulatory control of equipment. Encapsulating the equipment and its control such as control of values, drives, and so forth. At 1020, a Material Control Module (MCM) can be provided. Management of Material resource instances which are represented as sub-lots including change in location, quality status, availability, order status, logic that can be performed on material sub-lots, generation of material events such as consumed, produced and moved events, sub-lot combination, expiry dates, and so forth.

At 1030, a Personnel Control Module (PCM) is provided. This includes management of individual people such as Active, Idle, Break states directly or via shift schedules. This also includes data associated with people such as shift time patterns, for example. Other attributes that can be managed by PCM 1030 are a person's location in a plant (GPS), qualification checks, or current assignment, for example. At 1040, a Segment Control Module (SCM) includes manipulation of simple segment tasks such as piping paths, AGV paths, device state machines, robotic sequences and so forth. The SCM 1040 typically performs an action on one segment such as next step to execute after the current step. At 1050, a Storage Control Module (STGCM) includes Manipulation of simple storage logic such as buffer capacity and ordering into and out of a queue for the respective storage unit or requirement.

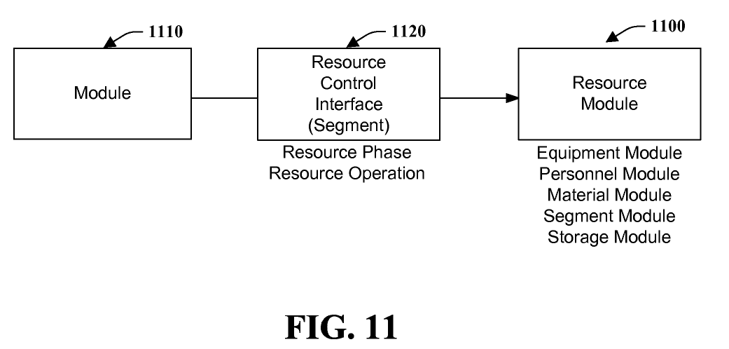

FIG. 11 illustrates a resource module 1100 for an industrial control system. Resource modules 1100 extend resource control modules described above to enable coordination of resources (equipment, people, modules and so forth) to achieve. As shown, the resource control module 1100 includes a module 1110 and a resource control interface 1120. Resource modules 1100 are also able to represent more complex activities than resource control modules. For example, resource modules can include other resource control modules at 1110 and/or other resource modules. For example, an equipment module can leverage a subordinate material control module to represent material handling aspects or a segment module to solicit an electronic signature.

Before proceeding it is noted that other types of modules are possible than shown. For instance, a configuration module can include management definitions and configuration of resources—personnel, segments, equipment, segments, storage, and so forth. Another type of module includes nested modules where a module references other modules. These modules can be children of a parent module or shared from one module to another. Resource modules can include resource control modules however resource control modules should not include resource modules. Modules can include modules focused on other resource types, for example an equipment module can include equipment modules and material modules.

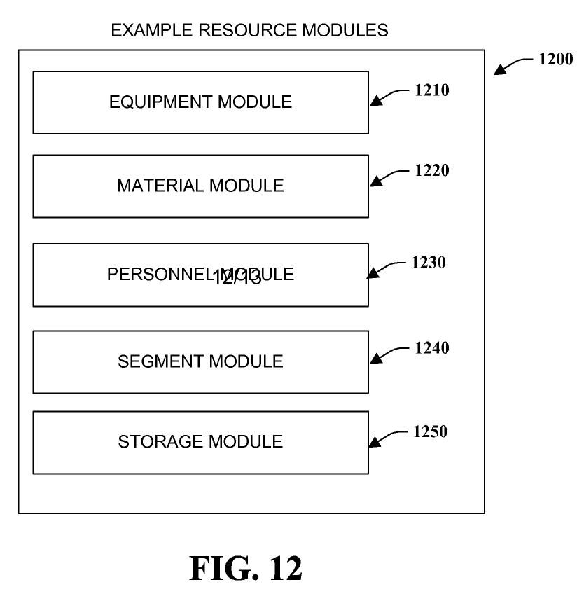

FIG. 12 illustrates example resource modules 1200 for an industrial control system. At 1210, an Equipment Module provides coordination of equipment modules and equipment control modules to perform a process-orientated task independent of specific material e.g., In-feed, AGV controller, Conveyor, and so forth. At 1220, a Material Module provides coordination of material modules and material control modules to perform material focused tasks e.g., Material reservation, provision, material mass balance calculation, Bill of Material management, Work order management, and so forth. At 1230, a Personnel Module provides coordination of personnel modules and personnel control modules to perform personnel focused tasks e.g., Electronic signature collection, Security validation, certification validation, Manual control interactions, and so forth.

At 1240, a Segment Module provides coordination of segment modules and segment control modules and to execute sequences of tasks represented by segments. Segments define resource requirements and ordering that can represent most production and process activities. This module provides access to more complex tasks that require specific sequences to be followed e.g., Process Analytics Technology (PAT) integration, electronic signatures collection, defect, process deviation and fault recovery processing. The segment module 1240 can also construct a sequence to be followed that can be applied as manual, automatic or semi automatic sequences (e.g., Route, recipe execution) At 1250, a Storage Module provides coordination of storage related activities, allocation of storage to requesters, modeling of inventory calculations and so forth. This also includes interaction with higher-level systems that manage storage and inventory information.

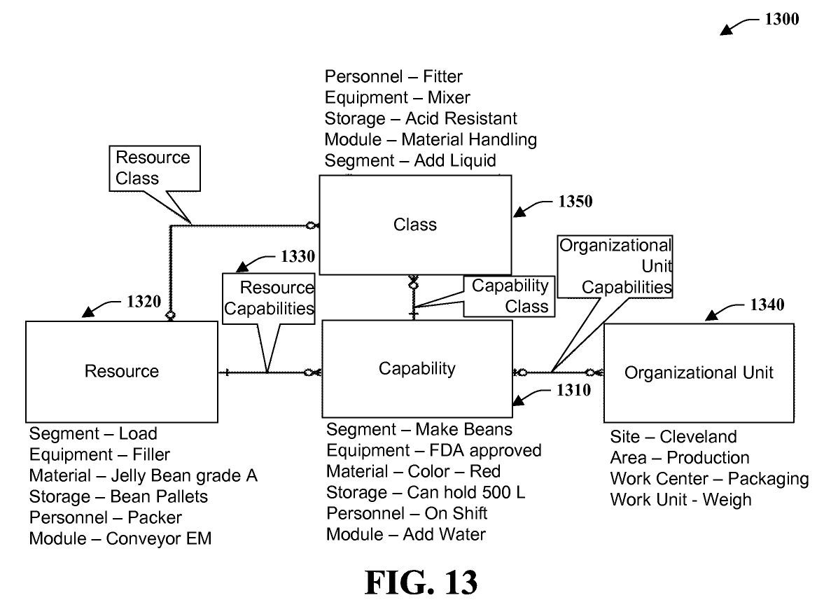

FIG. 13 illustrates an example resource control model 1300 for an industrial control system. Resource Control Interfaces are the interfaces exposed to production management systems for resource binding and arbitration purposes. The interfaces are elements of the resource control model 1300 including procedures, operations or phases. These interfaces are made available by exposure via one or more capabilities 1310 described below. Procedures, operations and phases depicted in this model 1300 are commonly referred to in association with their module resource type such as Equipment Phase, Personnel Phase, Segment Phase, or as a generic Resource Phase where no specific resource module is required. Production management including Product Production Rules (production route or control recipe) physically bind to (reference) resource control phases to perform work. The availability of other resources 1320 such as material, equipment, personnel are considered during the binding process of product production rules to work centers (production lines, process cells, and so forth). These selection processes evaluate resource capabilities to locate the appropriate resource for the task.

Resource capabilities 1310 include the resource 1320 required to perform work in a production system. Consequently, resources 1320 are at the centre of, efficiency, capacity, scheduling and arbitration considerations. A resource's ability to work or be available to allow work to commence is represented as resource capability at 1330. The existence of capability 1330 associated with a resource 1320 does not make the resource available for production; the resource's capability 1330 is associated with organizational units 1340 that are will support the respective resource capability. For example, an operator (personnel resource) can have qualifications for a Mixer in line 1, where this qualification capability is only in effect with that specific mixer unless explicitly directed. Resource arbitration algorithms can search for resource capabilities 1330 in the scope of organizational units 1340 they are to be executed within.

Resources 1320 publish capabilities to organizational units 1340 for use by system processes in a given scope. Modules are a type of resource and can be accessed directly by published capabilities 1310. However, a more common interface to Resource Modules is via verbs that are supported by the Resource Module noted above. These verbs are Resource Control elements (phases, operations, procedures . . . ) which are segments. A published capability of a resource module is typically one of the phases supported the module. Resource control interfaces are published (made available) to the outside world as capabilities 1310. Resource modules provide the ability to promote a command to become a resource control interface.

Some process control systems are built using only Resource control modules (especially control modules). Examples of this are continuous processes such as petrochemical and heavy chemical plants. In order to initiate, the process takes a plant up to its running state or makes a change to the state of a series of commands that are initiated and coordinated to achieve the new state. It is also possible to promote commands from resource control modules to appear as capabilities that can be accessed as “tuning knobs” for tweaking the system between system states. As shown in the model 1300, the resource 1320 and capability can be associated with a higher-level class or abstraction 1350.

What has been described above includes various exemplary aspects. It is, of course, not possible to describe every conceivable combination of components or methodologies for purposes of describing these aspects, but one of ordinary skill in the art can recognize that many further combinations and permutations are possible. Accordingly, the aspects described herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for module organization, comprising:
a communication component that enables interaction between a primary module and at least one subsequent module; and
a synchronization component that coordinates operation of the primary module with at least one subsequent module through utilization of the communication component, wherein the synchronization component is integrated upon the primary module.

2. The system of claim 1, further comprising a security component that determines validity of information that travels between the primary module and at least one subsequent module.

3. The system of claim 1, further comprising an error check component that identifies at least one error produced through coordination between the primary module and at least one subsequent module

4. The system of claim 1, further comprising artificial intelligence that makes at least one inference or at least one determination or at least one of each in relation to coordination between the primary module and at least one subsequent module.

5. The system of claim 1, wherein coordination comprises transmission of a status of the primary module to at least one subsequent module.

6. The system of claim 1, further comprising a configuration component that determines the synchronization component to integrate with the primary module or the primary module to integrate with the synchronization component.

7. The system of claim 1, further comprising a construction component that integrates the synchronization component upon the primary module.

8. The system of claim 7, further comprising a test component that determines if the primary module integrated with the synchronization component is suitable for coordination with at least one subsequent module.

9. The system of claim 1, further comprising a safety component that performs a failure control operation upon a primary module or subsequent module.

10. The system of claim 9, wherein the synchronization component is a module embedded in the safety component.

11. The system of claim 9, wherein the safety component utilizes a resource to perform a failure control operation.

12. The system of claim 11, wherein the resource is a presence sensor device, a safety switch, an interlock switch, a safety relay, an emergency stop device, a cable pull and enable switch, a safety controller, or a combination thereof.

13. The system of claim 1, further comprising an activation component that places the primary module in a state capable of coordinating with at least one subsequent module.

14. The system of claim 1, wherein the primary module coordinates operation with at least one subsequent module that is part of a process.

15. The system of claim 1, wherein at least one subsequent module integrates with another synchronization component that is used to coordinate operation.

16. A method for synchronizing modules in a control environment, comprising:
embedding at least one synchronization component within a module to determine status of the module or communicate status of the module; and
employing the synchronization component to coordinate operations with at least one other module.

17. The method of claim 16, further comprising performing a test upon at least one synchronization component, wherein a result of the test is used to determine if at least one synchronization component is to be embedded within a module.

18. The method of claim 16, further comprising making at least one modification based on coordination between the synchronization component and at least one other module.

19. The method of claim 18, further comprising determining if the modification creates at least one error.

20. The method of claim 19, further comprising altering operation of at least one module if it is determined that the modification creates at least one error.

21. The method of claim 20, wherein altering operation eliminates the error.

22. A system for module manipulation, comprising:
means for constructing a module and a synchronization component into a single unit; and
means for activating the single unit to coordinate with at least one other module.

23. The system of claim 22, further comprising means for testing the single unit.

24. The system of claim 22, further comprising means for determining a module to construct into a single unit or a synchronization component to construct into a single unit.
